(19) United States
(12) Patent Application Publication
(10) Pub. No.: US 2025/0163921 A1
(43) Pub. Date: May 22, 2025

(54) ELECTRIC COMPRESSOR

(71) Applicant: SANDEN CORPORATION, Gunma (JP)

(72) Inventors: Mikio KOBAYASHI, Gunma (JP); Kazuya IIZUKA, Gunma (JP)

(21) Appl. No.: 18/835,274

(22) PCT Filed: Jan. 24, 2023
(86) PCT No.: PCT/JP2023/002091

§ 371 Date: Aug. 1, 2024

(30) Foreign Application Priority Data
Feb. 18, 2022 (JP) 2022-024095

(51) Int. Cl. F04D 25/06; F04B 49/06

(52) U.S. Cl. CPC F04D 25/068; F04B 49/06

(57) ABSTRACT

To improve heat dissipation performance and insulation performance of a drive circuit that drives an electric motor. In an electric compressor configured such that an inverter that drives an electric motor which is a power source for a compression mechanism is installed integrally with a housing that houses the compression mechanism and the electric motor, an installation target surface of a second partition wall for a package enclosing a switching element of the inverter is provided as the bottom surface of a recessed part formed in the second partition wall, the package is fixed in such a manner that a thread portion of a bolt inserted into a bolt insertion hole of the package is screwed into a screw hole formed in the installation target surface of the second partition wall, and the recessed part is filled with a sealing material.

### TECHNICAL FIELD

The present invention relates to an electric compressor configured such that a drive circuit that drives an electric motor which is a power source for a compression mechanism is installed integrally with a housing that houses the compression mechanism and the electric motor.

### BACKGROUND ART

As an electric compressor, for example, as described in Patent Literature 1, there has been known an electric compressor configured such that a bolt is inserted into a bolt insertion hole drilled in a package enclosing a switching element of an inverter and is screwed to a base plate and the package is pressed against and fixed to the base plate. An insulating sheet having favorable thermal conductivity is interposed between a conductive heatsink provided on the bottom surface of the package and the base plate in order to promote heat dissipation from the heatsink and reduce discharge. In order to increase an insulation distance from the heatsink to the bolt, an insulating member is provided, which is configured such that a cylindrical body extends from a base disposed in a groove of the base plate and sandwiched between the insulating sheet and the bottom surface of the groove by pressing force in bolt screwing into the bolt insertion hole of the package along a bolt thread portion.

### CITATION LIST

### Patent Literature

Patent Literature 1: JP-A-2020-198713

### SUMMARY OF INVENTION

### Problems to be Solved by Invention

An electric compressor used in a refrigeration cycle of a vehicle air conditioner has been required to be applicable to a high voltage of, for example, 800 V or more for the purpose of, e.g., application to quick charging, output density improvement, and loss reduction in association with an increase in the battery capacity of an electric vehicle. For this reason, enhancement of the heat dissipation performance and insulation performance of the inverter has been demanded more than before.

However, in the electric compressor described in Patent Literature 1, the pressing force in bolt screwing is limited according to the allowable mechanical stress of the switching element, and the dimensions of the insulating member, the bolt insertion hole, and the groove usually include manufacturing tolerances. For this reason, extremely-small gaps are generated between the insulating sheet and each of the heatsink and the base plate and between the insulating member and each of the bottom surface of the groove and the insulating sheet, and there is a possibility that the heat dissipation performance and insulation performance of the inverter are not sufficiently applicable to the high voltage of the electric compressor.

In view of the above-described typical problems, an object of the present invention is to provide an electric compressor configured such that the heat dissipation performance and insulation performance of a drive circuit that drives an electric motor are improved.

### Solution to Problems

In order to accomplish the above-described object, an electric compressor of the present invention is configured such that a drive circuit that drives an electric motor which is a power source for a compression mechanism is installed integrally with a housing that houses the compression mechanism and the electric motor, an installation target surface of the housing for a package enclosing a switching element of the drive circuit is provided as the bottom surface of a recessed part formed in the housing, the package is fixed in such a manner that a thread portion of a bolt inserted into a bolt insertion hole of the package is screwed into a screw hole formed in the installation target surface, and the recessed part is filled with a sealing material.

### Effects of Invention

According to the electric compressor of the present invention, it is possible to improve the heat dissipation performance and insulation performance of the drive circuit that drives the electric motor.

### BRIEF DESCRIPTION OF DRAWINGS

FIG. 1 is a diagram for describing one example of a refrigeration cycle to which an electric compressor is applied.

FIG. 2 is a schematic sectional view of the electric compressor.

FIG. 3 is a perspective view illustrating a package from above.

FIG. 4 is a perspective view illustrating the package from below.

FIG. 5 is a schematic sectional view taken along line A-A in FIG. 3.

FIG. 6 is a schematic sectional view illustrating components used for package installation.

FIG. 7 is a perspective view illustrating one example of a spacer.

FIG. 8 is a schematic sectional view illustrating a screwed state of the package.

FIG. 9 is a schematic sectional view illustrating a sealed state of the package.

FIG. 10 is a perspective view illustrating a specific installation form of the package.

FIG. 11 is a perspective view illustrating a first modification of the spacer.

FIG. 12 is a sectional view taken along line B-B in FIG. 11.

FIG. 13 is a schematic sectional view illustrating a package sealed state with the spacer of the first modification.

FIG. 14 is a perspective view illustrating a second modification of the spacer.

FIG. 15 is a sectional view taken along line C-C in FIG. 14.

FIG. 16 is a schematic sectional view illustrating a package sealed state with the spacer of the second modification.

FIG. 17 is a schematic sectional view illustrating a screwed state of a typical package.

### DESCRIPTION OF EMBODIMENTS

Hereinafter, embodiments of the present invention will be described in detail with reference to the attached drawings.

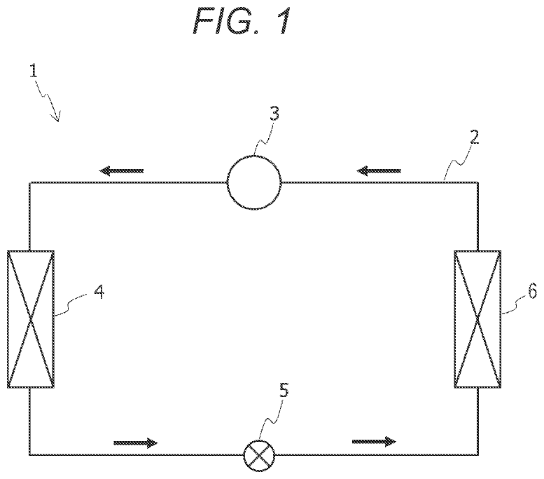

FIG. 1 illustrates one example of a refrigeration cycle using an electric compressor.

A refrigeration cycle 1 is a vapor pressure refrigeration cycle formed in such a manner that an electric compressor 3, a condenser 4, an expansion valve 5, and an evaporator 6 are arranged in this order on a refrigerant pipe 2 through which refrigerant circulates. The electric compressor 3 compresses low-temperature low-pressure gas refrigerant into high-temperature high-pressure gas refrigerant. The condenser 4 cools the high-temperature high-pressure gas refrigerant having passed through the electric compressor 3 into low-temperature high-pressure liquid refrigerant. The expansion valve 5 decompresses the low-temperature high-pressure liquid refrigerant into low-temperature low-pressure liquid refrigerant. The evaporator 6 vaporizes the low-temperature low-pressure liquid refrigerant into low-temperature low-pressure gas refrigerant. This refrigeration cycle 1 can be applied to various devices such as an air conditioner and a heat pump regardless of whether the refrigeration cycle 1 is of an on-vehicle type or a stationary type.

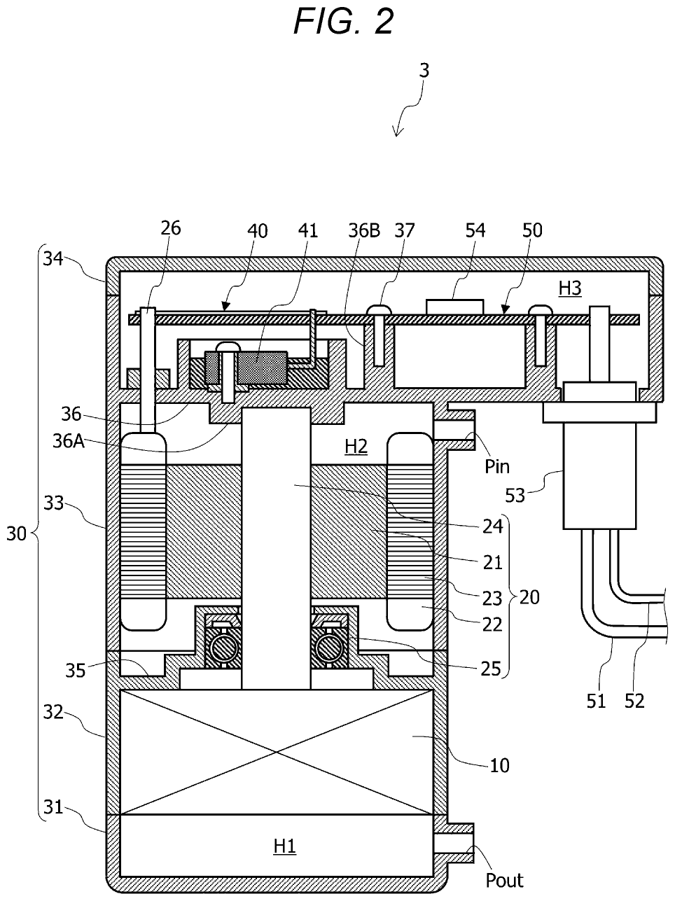

FIG. 2 illustrates one example of the electric compressor 3. The electric compressor 3 is configured such that an inverter 40 which is a drive circuit for an electric motor 20 which is a drive source for a compression mechanism 10 is installed integrally with a housing 30 housing the compression mechanism 10 and the electric motor 20.

The housing 30 is a hollow body having an internal closed space formed by fastening a rear housing 31, a center housing 32, a front housing 33, and an inverter cover 34 with a fastener such as a bolt and a washer, and is made of metal such as aluminum alloy. The internal closed space is generally divided into three spaces in series by a first partition wall 35 and a second partition wall 36. Specifically, a first space H1 is formed by fastening the rear housing 31 and the center housing 32 having the first partition wall 35, and the compression mechanism 10 is housed in the first space H1. A second space H2 is formed by fastening the center housing 32 having the first partition wall 35 and the front housing 33 having the second partition wall 36, and the electric motor 20 is housed in the second space H2. A third space H3 is formed by fastening the front housing 33 having the second partition wall 36 and the inverter cover 34, and the inverter 40 is housed in the third space H3.

The rear housing 31 is provided with a discharge port Pout for discharging the high-temperature high-pressure gas refrigerant generated by the compression mechanism 10 from the first space H1 to the outside. The front housing 33 is provided with a suction port Pin for sucking the low-temperature low-pressure gas refrigerant vaporized by the evaporator from the outside to the second space H2. In the center housing 32, a not-illustrated communication path causing the first space H1 and the second space H2 to communicate with each other is formed, and the low-temperature low-pressure gas refrigerant sucked into the second space H2 through the suction port Pin is introduced into the first space H1 through the communication path.

The compression mechanism 10 has a movable body driven by the rotational output of the electric motor 20, and compresses the low-temperature low-pressure gas refrigerant introduced into the first space H1 by motion of the movable body, thereby generating the high-temperature high-pressure gas refrigerant. Any compression method can be adopted for the compression mechanism 10 as long as the rotational output of the electric motor 20 is used. For example, a scroll type compression mechanism 10 can be adopted, in which revolving motion of an orbiting scroll is generated using the rotational output of the electric motor 20 to change the volume of a compression chamber formed by engagement between a fixed scroll and the orbiting scroll. Alternatively, a rotary type compression mechanism 10 can be adopted, in which a rotor in a casing is rotated by the rotational output of the electric motor 20 to continuously change the volume of a compression chamber formed between the casing and the rotor.

Although not illustrated, a discharge chamber for temporarily storing the high-temperature high-pressure gas refrigerant generated by the compression mechanism 10 to reduce pulsation and a gas-liquid separation chamber for separating lubricant oil from the high-temperature high-pressure gas refrigerant may be provided in the first space H1.

The electric motor 20 is, for example, a three-phase permanent magnet synchronous motor, and has a substantially columnar or cylindrical rotor 21 in which permanent magnets are sequentially arranged in a circumferential direction, and a stator 23 configured such that a plurality of teeth around which stator coils 22 are wound and which faces the outer peripheral surface of the rotor 21 is arranged along the circumferential direction. A motor shaft 24 extending in a direction perpendicular to a radial direction is fixed to the center of the rotor 21 in the radial direction. One end portion of the motor shaft 24 is rotatably supported by a support portion 36A provided in the second partition wall 36 of the front housing 33 through a not-illustrated sliding bearing. The other end portion of the motor shaft 24 penetrates the first partition wall 35 of the center housing 32 and is coupled to the movable body of the compression mechanism 10, and the motor shaft 24 is also rotatably supported by a bearing 25 disposed on the first partition wall 35 in the first space H1. With this configuration, the rotor 21 rotates relative to the stator 23 with the axis of the motor shaft 24 as a rotation axis. A connection terminal 26 for electrically connecting the stator coil 22 of each phase to the inverter 40 stands on the stator 23 and airtightly penetrates the second partition wall 36, and the connection terminal 26 and the second partition wall 36 are insulated from each other. When a rotating magnetic field is generated in the stator coil 22 by power distribution from the inverter 40 through the connection terminal 26, rotational force is generated in the rotor 21, and the rotational output of the electric motor 20 is transmitted to the movable body of the compression mechanism 10 through the motor shaft 24.

The inverter 40 is a power conversion device including a three-phase bridge circuit having six switching elements 41, converting direct current input from an external DC power supply into three-phase alternating current by the three-phase bridge circuit, and supplying the three-phase alternating current to the stator coil 22 of the electric motor 20. The three-phase bridge circuit is configured such that phase arms, in each of which two switching elements 41 are connected in series, are connected in parallel between a positive-side bus and a negative-side bus connected to the external DC power supply, and the two switching elements 41 of each phase arm are connected to the connection terminal 26 of the stator coil 22 of the corresponding phase.

The six switching elements 41 of the three-phase bridge circuit of the inverter 40 are installed on the second partition wall 36. Since the switching elements 41 are installed on the second partition wall 36, heat dissipation of the switching elements 41 is promoted by a heat absorption effect of the low-temperature low-pressure gas refrigerant sucked into the second space H2 through the suction port Pin. A portion of the inverter 40 other than the six switching elements 41 of the three-phase bridge circuit is formed on a circuit board 50 screwed to a boss portion 36B standing on the second partition wall 36 with a bolt 37 and extending substantially parallel to and apart from the second partition wall 36. A conductive path of the three-phase bridge circuit other than the six switching elements 41 is formed as a conductive pattern on the circuit board 50, and the conductive pattern and the connection terminal 26 are electrically connected to each other. A power supply line 51 connected to a positive electrode and a negative electrode of the external DC power supply and a signal line 52 through which an operation command for the electric compressor 3 is transmitted from the outside are electrically connected to the circuit board 50 through a removable connector 53. The power supply line 51 is connected to the conductive patterns of the positive-side bus and the negative-side bus of the inverter 40, and the signal line 52 is connected to a control circuit 54, such as a microcomputer, mounted on the circuit board 50.

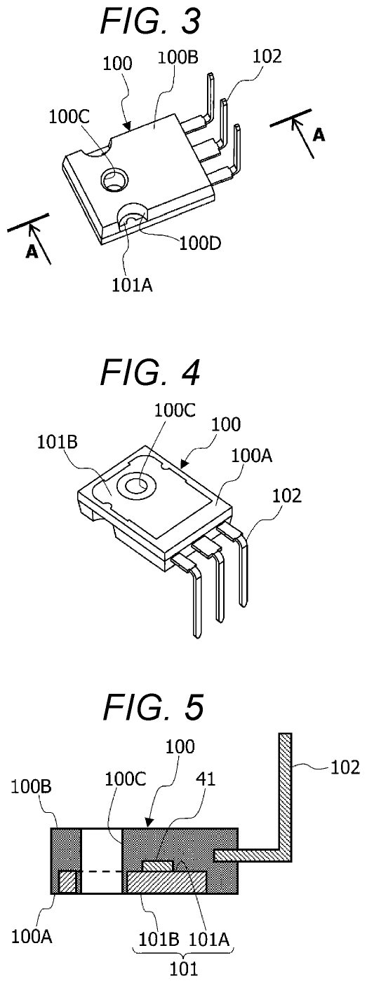

Next, a specific form of the switching element 41 will be described with reference to FIGS. 3 to 5. As described later, the switching element 41 is enclosed in a package. FIG. 3 illustrates the package from above, FIG. 4 illustrates the package from below, and FIG. 5 illustrates the section of the package.

The switching element 41 is a power semiconductor element that performs switching operation based on a control signal output from the control circuit 54, such as an insulated gate bipolar transistor (IGBT), and is formed as a semiconductor chip including an electrode pad for electrical connection with the outside. The switching element 41 is enclosed in a package 100 in such a manner that the switching element 41 is sealed with a predetermined sealing material such as resin molding with epoxy resin. The package 100 is formed in a substantially flat rectangular parallelepiped shape having a flat installation surface for installing the package 100 on the second partition wall 36 as a bottom surface 100A, and has a die pad 101 and a lead 102 in addition to the switching element 41. The die pad 101 is a metal plate for supporting and fixing the switching element 41 through an insulating layer and dissipating heat generated in the switching element 41. The switching element 41 is supported on and fixed to one surface 101A of the die pad 101, and a back surface 101B of the die pad 101 opposite to the one surface 101A is exposed to the outside so as to be flush with the bottom surface 100A of the package 100. The lead 102 is a metal terminal for electrically connecting the switching element 41 and the conductive pattern on the circuit board 50 to each other, and may be punched from the same lead frame as that for the die pad 101. One end portion of the lead 102 is electrically connected to the electrode pad of the switching element 41 by, for example, wire bonding, and the other end portion of the lead 102 extends to the outside of the package 100 and is formed in an L-shape for connection with the conductive pattern of the circuit board 50.

In order to insert a bolt for fixing the package 100 to the second partition wall 36, a bolt insertion hole 100C penetrating the package 100 from the bottom surface 100 A to a top surface 100B opposite to the bottom surface 100A and separated from the switching element 41, the die pad 101, and the lead 102 is drilled in advance in the package 100. In a case where the package 100 is formed by molding the switching element 41 with resin, the die pad 101 is pressed by pressing pins from both the one surface 101A and the back surface 101B in resin molding. Thus, the package 100 is formed with cutouts 100D in which the resin is cut out and the one surface 101A side of the die pad 101 is exposed to the outside.

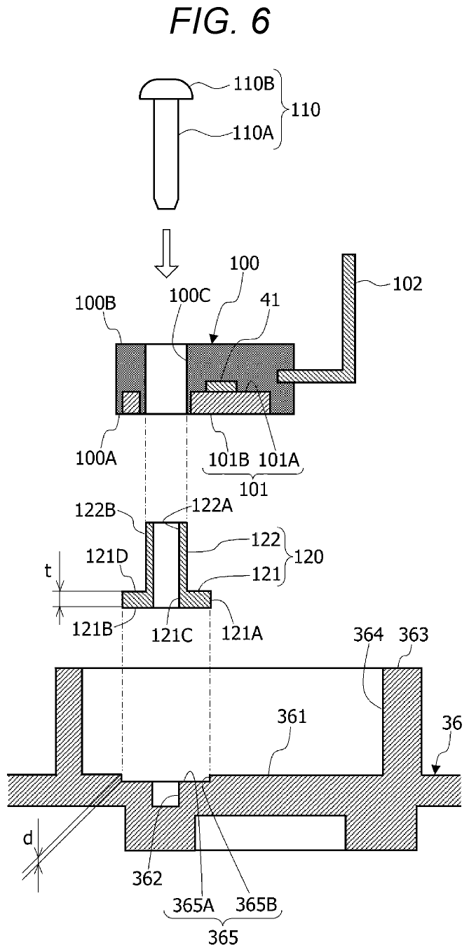

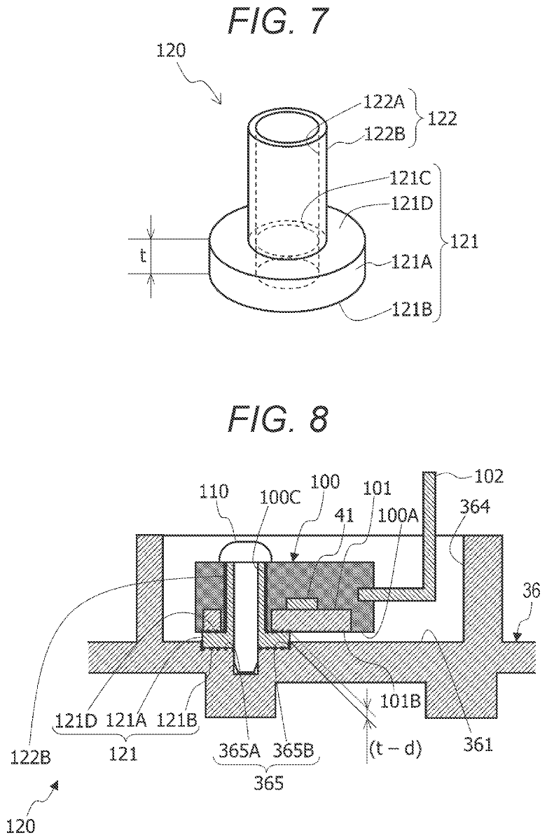

Next, a method for installing the package 100 on the second partition wall 36 will be described with reference to FIGS. 6 and 7. FIG. 6 illustrates a structure related to installation of the package 100. FIG. 7 illustrates one example of a spacer among components used for installation of the package 100 on the second partition wall 36.

As illustrated in FIG. 6, an internal thread hole 362 to be screwed with a thread portion 110A of a bolt 110 is formed in an installation target surface 361 for the package 100, which is formed flat in the second partition wall 36. The package 100 is installed on the second partition wall 36 by screwing the thread portion 110A of the bolt 110, which is inserted into the bolt insertion hole 100C from the top surface 100B side, into the internal thread hole 362 with the bottom surface 100A facing the installation target surface 361 of the second partition wall 36. As the bolt 110, one having the thread portion 110A which can be inserted into the bolt insertion hole 100C and a head portion 110B which cannot be inserted into the bolt insertion hole 100C is selected.

A partitioning wall 363 stands on the second partition wall 36 so as to surround the entire circumference of the installation target surface 361, and a region surrounded by the partitioning wall 363 is formed as a recessed part 364. In other words, the installation target surface 361 is formed as the bottom surface of the recessed part 364. The height of the partitioning wall 363 with respect to the installation target surface 361 of the second partition wall 36 is higher than both a location from which the lead 102 protrudes from the package 100 to the outside and a location at which the one surface 101A side of the die pad 101 is exposed through the cutout 100D in a state of the package 100 being installed on the second partition wall 36.

In the installation target surface 361 of the second partition wall 36, a groove 365 is formed so as to be recessed by a predetermined depth d with respect to the installation target surface 361 at the periphery of the opening of the internal thread hole 362. A spacer 120 having favorable insulation is disposed on the bottom surface 365A of the groove 365, and is positioned on the installation target surface 361 by the inner peripheral surface 365B of the groove 365. The package 100 is screwed with the bolt 110, and in this manner, is pressed toward the second partition wall 36 through the spacer 120.

As illustrated in FIGS. 6 and 7, the spacer 120 includes a base 121 and a cylindrical body 122. The base 121 has an outer peripheral surface 121A to be fitted in the groove 365, has a predetermined constant thickness t from a bottom surface 121B configured to contact the bottom surface 365A of the groove 365, and has a through-hole 121C, through which the thread portion 110A of the bolt 110 is to be inserted, in a portion corresponding to the internal thread hole 362 in a state of being fitted in the groove 365. The predetermined thickness t of the base 121 is greater than the predetermined depth d of the groove 365. The cylindrical body 122 has an inner peripheral surface 122A extended from the inner peripheral surface of the through-hole 121C so as to extend in the insertion direction of the thread portion 110A of the bolt 110 from the peripheral edge of the through-hole 121C in the top surface 121D of the base 121 opposite to the bottom surface 121B, and has an outer peripheral surface 122B insertable into the bolt insertion hole 100C of the package 100. When the package 100 is installed on the second partition wall 36, the cylindrical body 122 is inserted into a gap between the outer peripheral surface of the thread portion 110A of the bolt 110 and the inner peripheral surface of the bolt insertion hole 100C. The base 121 is sandwiched between the bottom surface 365A of the groove 365 and the bottom surface 100A of the package 100 by screwing the package 100 to the second partition wall 36 with the bolt 110.

FIG. 8 illustrates a screwed state of the package 100 in which the package 100 is screwed to the second partition wall 36 with the bolt 110. As illustrated in FIG. 8, in the screwed state of the package 100, a gap having a clearance (t-d) which is a difference between the predetermined thickness t and the predetermined depth d is generated between the bottom surface 100A of the package 100 and the installation target surface 361 of the second partition wall 36.

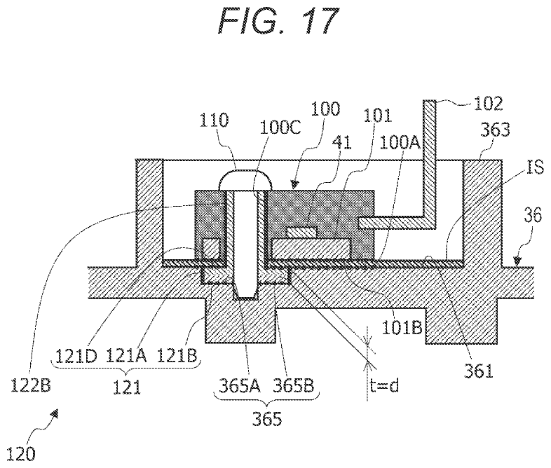

Here, a reason why the gap having the clearance (t-d) is formed as illustrated in FIG. 8 will be described with reference to FIG. 17. FIG. 17 illustrates a typical screwed state of the package 100, in which the top surface 121D of the base 121 and the installation target surface 361 of the second partition wall 36 are flush with each other with the predetermined thickness t and the predetermined depth d in FIG. 8 as the same value and an insulating sheet IS having favorable thermal conductivity is interposed between the bottom surface 100A of the package 100 and each of the installation target surface 361 of the second partition wall 36 and the top surface 121D of the base 121.

In FIG. 17, the package pressing force in screwing of the bolt 110 is limited according to the allowable mechanical stress of the switching element 41. In addition, the predetermined thickness t of the base 121 and the predetermined depth d of the groove 365 usually include manufacturing tolerances. Due to at least one of these two factors, as indicated by a thick broken line in the screwed state of the package 100 of FIG. 17, extremely-small gaps are generated between the bottom surface 100A of the package 100 and the insulating sheet IS, between the insulating sheet IS and each of the installation target surface 361 of the second partition wall 36 and the top surface 121D of the base 121, and between the bottom surface 121B of the base 121 and the bottom surface 365A of the groove 365. In addition, due to the manufacturing tolerances of the bolt insertion hole 100C, the spacer 120, the groove 365, and the insulating sheet IS, as indicated by a thick solid line in the figure, extremely-small gaps are also generated between the inner peripheral surface of the bolt insertion hole 100C and the outer peripheral surface 122B of the cylindrical body 122, between the inner peripheral surface 365B of the groove 365 and the outer peripheral surface 121A of the base 121, and between the insulating sheet IS and the outer peripheral surface 122B of the cylindrical body 122. All these extremely-small gaps may be part of a discharge path from the back surface 101B of the die pad 101 to the bolt 110 or the installation target surface 361 of the second partition wall 36, and both these discharge paths follow complicated paths as compared to the shortest distance from the back surface 101B of the die pad 101 to the bolt 110 or the installation target surface 361 of the second partition wall 36 and an insulation distance is long. In particular, in the discharge path from the back surface 101B of the die pad 101 to the nearest bolt 110, the insulation distance is long due to the presence of the spacer 120. For this reason, if the electric compressor 3 is driven with a relatively-low voltage, the influence of the above-described extremely-small gaps on the insulation performance and heat dissipation performance of the inverter 40 is small. However, in a case where the electric compressor 3 is driven with, e.g., a relatively-high voltage of 800 V or more, even if there are the above-described extremely-small gaps, insulation breakdown may occur or sufficient heat dissipation may be difficult, and for this reason, the insulation performance and heat dissipation performance of the inverter 40 may be insufficient. Thus, in order to reduce the above-described extremely-small gaps as much as possible, the gap having the clearance (t-d) is intentionally formed as illustrated in FIG. 8 in order to charge a flowable (for example, liquid) sealing material between the installation target surface 361 of the second partition wall 36 and the bottom surface 100A of the package 100 instead of the insulating sheet IS.

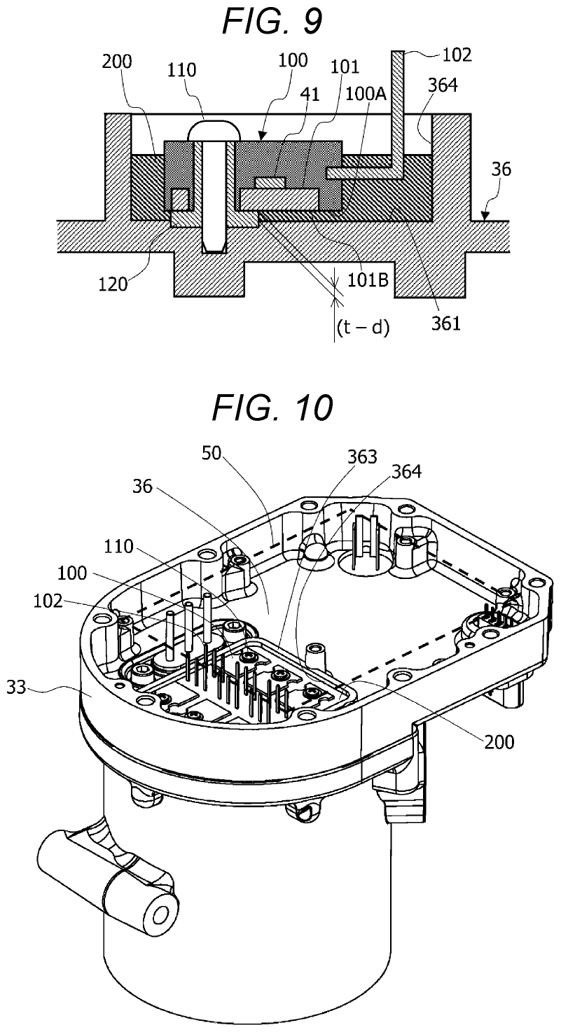

FIG. 9 illustrates a sealed state in which the package 100 is sealed with the flowable sealing material. A flowable sealing material 200 is a material having favorable insulation and thermal conductivity, such as a resin composition (silicon resin, urethane resin, epoxy resin), and the recessed part 364 is filled with the flowable sealing material 200 by, e.g., potting in the screwed state of the package 100 of FIG. 8. The flowable sealing material 200 may be charged by vacuuming the entire front housing 33 or the recessed part 364 in which the package 100 is screwed to the second partition wall 36. The flowable sealing material 200 spreads on the installation target surface 361 in the recessed part 364, the surface height thereof increases, and the gap having the clearance (t-d) is first filled.

As indicated by a thick broken line In the screwed state of the package 100 of FIG. 8, extremely-slight gaps are generated between the bottom surface 100A of the package 100 and the top surface 121D of the base 121 and between the bottom surface 121B of the base 121 and the bottom surface 365A of the groove 365 due to at least one of the two factors which are the limitation of the package pressing force in screwing of the bolt 110 and the manufacturing tolerances of the predetermined thickness t of the base 121 and the predetermined depth d of the groove 365. In addition, as indicated by a thick solid line in the figure, due to the manufacturing tolerances of the bolt insertion hole 100C, the spacer 120, and the groove 365, extremely-small gaps are also generated between the inner peripheral surface of the bolt insertion hole 100C and the outer peripheral surface 122B of the cylindrical body 122 and between the inner peripheral surface 365B of the groove 365 and the outer peripheral surface 121A of the base 121. By appropriately selecting the flowable sealing material 200 from the viewpoint of, e.g., viscosity, the flowable sealing material 200 charged into the gap having the clearance (t-d) is sucked into these extremely-small gaps by capillary action. As a result, the above-described extremely-small gaps are filled with the sealing material 200 until the insulation distance from the back surface 101B of the die pad 101 reaches a level sufficiently applicable to the high voltage of the electric compressor 3.

In a case where the electric compressor 3 is driven with a relatively-high voltage of, for example, 800 V or more, the base of the lead 102 protruding to the outside from the package 100 is assumed as a discharge destination from the back surface 101B of the die pad 101. Although not illustrated in FIG. 9, the front surface side of the die pad 101 exposed through the cutout 100D is also assumed as the discharge destination. Thus, the flowable sealing material 200 is charged into the recessed part 364 so as to seal the discharge destination assumed as described above. Even after such charging, the partitioning wall 363 standing to the location higher than both the location from which the lead 102 protrudes from the package 100 to the outside and the location at which the one surface 101A side of the die pad 101 is exposed through the cutout 100D makes it possible to avoid leakage and spread of the sealing material to the periphery.

The flowable sealing material 200 charged into the recessed part 364 is cured by, e.g., natural drying, heating, or ultraviolet irradiation. The height of the partitioning wall 363 with respect to the installation target surface 361 of the second partition wall 36 may be higher than the head portion 110B of the bolt 110 in the screwed state of the package 100. With this configuration, the sealing material 200 can be charged without leaking and spreading to the periphery until the surface height of the flowable sealing material 200 reaches a location higher than the head portion 110B of the bolt 110, whereby the possibility of discharge to the head portion 110B of the bolt 110 or discharge from the head portion 110B of the bolt 110 can also be reduced.

FIG. 10 illustrates a specific installation form of the package 100 on the second partition wall 36 in a state of the inverter cover 34 and the circuit board 50 being detached from the front housing 33. Six packages 100 individually enclosing the switching elements 41 are separated from each other, are arranged in lines with three packages 100 as one line, and are screwed to the second partition wall 36 with the bolts 110 in a state of the leads 102 of each package 100 of one line facing the leads 102 of the corresponding package 100 of the adjacent line. The six packages 100 are surrounded by one annular partitioning wall 363 separated therefrom, and the sealing material 200 is charged into the recessed part 364 formed by the partitioning wall 363 and is cured. In a case where it is difficult to surround the six packages 100 with one annular partitioning wall 363 due to the layouts of the circuit board 50 and the second partition wall 36, a plurality of partitioning walls 363 may be provided at different locations, and one or more packages 100 may be installed in the recessed part 364 formed by each partitioning wall 363. Instead of individually enclosing the switching elements 41 in the six packages 100, the switching elements 41 may be enclosed in one modularized package 100, and the package 100 may be installed on the second partition wall 36 in the recessed part 364 formed by one partitioning wall 363. As part of the partitioning wall 363, a peripheral wall of the front housing 33 surrounding the circuit board 50 can be used.

In the electric compressor 3 configured as described above, the gap having the clearance (t-d) is formed between the bottom surface 100A of the package 100 and the installation target surface 361 of the second partition wall 36 by the base 121 of the spacer 120, and is filled with the flowable sealing material 200 having favorable electric insulation and thermal conductivity. The extremely-small gap generated due to at least one of the two factors which are the limitation of the package pressing force in screwing of the bolt 110 and the manufacturing tolerances of the bolt insertion hole 100C, the spacer 120, and the groove 365 is filled when the flowable sealing material 200 charged into the gap having the clearance (t-d) enters the groove 365 due to the capillary action. In addition, the sealing material 200 is charged up to the base of the lead 102 protruding from the package 100 to the outside and the one surface 101A side of the die pad 101 exposed through the cutout 100D are sealed. Thus, the insulation distance from the back surface 101B of the die pad 101 to the discharge destination such as the bolt 110 and thermal resistance from the back surface 101B of the die pad 101 to the second partition wall 36 can be set to a level sufficiently applicable to the high voltage of the electric compressor 3.

In the electric compressor 3, the package 100 is installed on the installation target surface 361 which is the bottom surface of the recessed part 364 annularly surrounded by the partitioning wall 363 standing on the second partition wall 36, and therefore, even when the recessed part 364 is filled with the flowable sealing material 200, the leakage and spread of the sealing material 200 to the periphery of the partitioning wall 363 can be prevented and the amount of sealing material 200 to be used can be reduced.

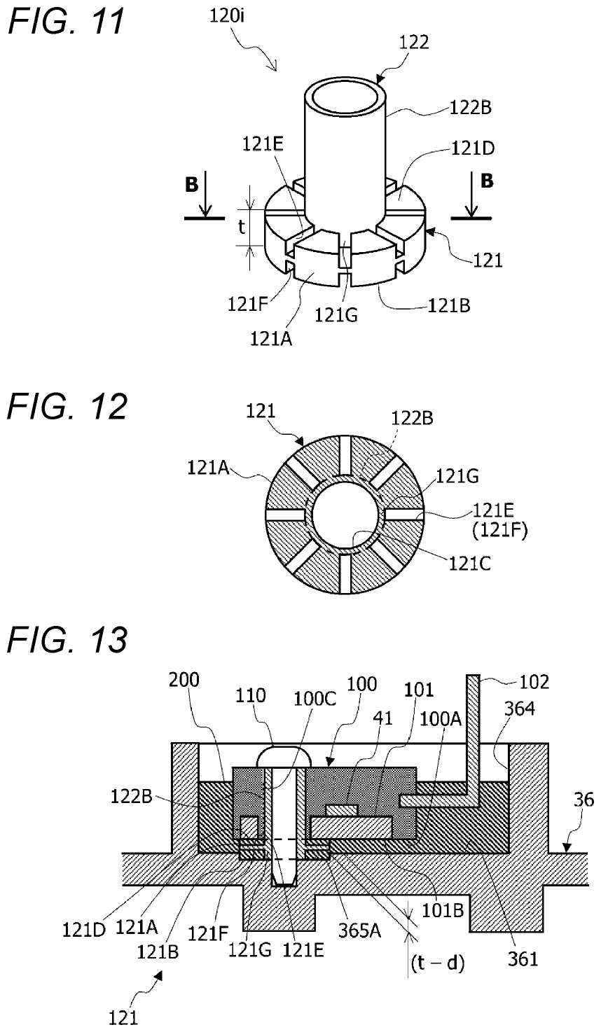

Next, a first modification of the spacer 120 will be described with reference to FIGS. 11 to 13. FIG. 11 illustrates a spacer according to the first modification. FIG. 12 illustrates the section of a base of the spacer according to the first modification. FIG. 13 illustrates the sealed state of the package 100 when the spacer according to the first modification is used. Components similar to those in the above-described embodiment are denoted by the same reference numerals, and description thereof will be omitted or simplified. The same also applies to the following modifications.

As illustrated in FIG. 11, a spacer 120i according to the present modification is configured such that the configuration of the base 121 is changed from that of the spacer 120. Specifically, in the spacer 120i, one or more recesses 121E formed in such a manner that the top surface 121D of the base 121 is recessed in a thickness direction and one or more recesses 121F formed in such a manner that the bottom surface 121B of the base 121 is recessed in the thickness direction are provided from the outer peripheral surface 121A toward the center. As illustrated in FIG. 12, as viewed from the top surface 121D of the base 121, the recesses 121E, 121F extend from the outer peripheral surface 121A of the base 121 to the outer peripheral surface 122B of the cylindrical body 122, and are separated by a peripheral wall 121G around the through-hole 121C.

As illustrated in FIG. 13, the flowable sealing material 200 charged into the gap having the clearance (t-d) enters the recesses 121E, 121F provided in the top surface 121D and bottom surface 121B of the base 121. In the recess 121E provided in the top surface 121D of the base 121, the flowable sealing material 200 flows to the peripheral wall 121G along the bottom surface 100A of the package 100. Moreover, in the recess 121F provided in the bottom surface 121B of the base 121, the flowable sealing material 200 flows to the peripheral wall 121G along the bottom surface 365A of the groove 365. The flowable sealing material 200 having flowed into the recesses 121E, 121F as described above is further sucked into the extremely-small gap between the top surface 121D of the base 121 and the bottom surface 100A of the package 100 and the extremely-small gap between the bottom surface 121B of the base 121 and the bottom surface 365A of the groove 365 by the capillary action. Thus, the recesses 121E, 121F are provided in the base 121 so that suction of the flowable sealing material 200 into the extremely-small gaps not only from the outer peripheral surface 121A of the base 121 but also from the recesses 121E, 121F due to the capillary action can be promoted and the charging efficiency of the sealing material 200 can be improved. Further, the flowable sealing material 200 charged into the gap having the clearance (t-d) easily reaches the inlet of the gap between the inner peripheral surface of the bolt insertion hole 100C and the outer peripheral surface 122B of the cylindrical body 122 through the recesses 121E provided in the top surface 121D of the base 121, and suction to the gap due to the capillary action is promoted. From this point, the charging efficiency of the sealing material 200 can also be improved.

Instead of the recesses 121E, 121F, the recess 121E in the top surface 121D and the recess 121F in the bottom surface 121B may be coupled to each other in the thickness direction of the base 121 to form a slit extending from the outer peripheral surface 121A to the through-hole 121C of the base 121.

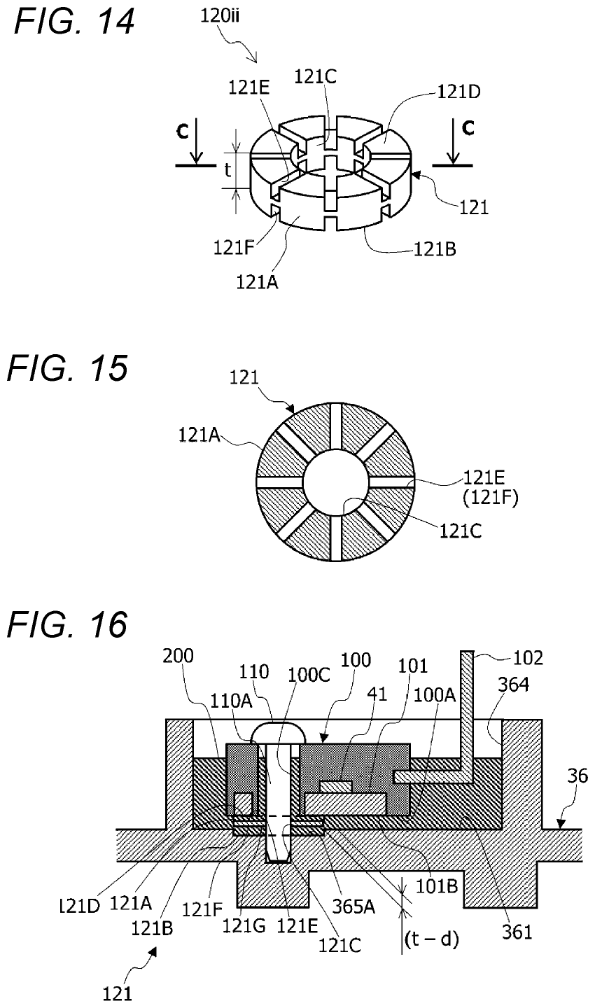

Next, a second modification of the spacer 120 will be described with reference to FIGS. 14 to 16. FIG. 14 illustrates a spacer according to the second modification. FIG. 15 illustrates the section of a base of the spacer according to the second modification. FIG. 16 illustrates the sealed state of the package 100 when the spacer according to the second modification is used.

As illustrated in FIG. 14, a spacer 120ii according to the present modification is configured such that the cylindrical body 122 is omitted from the spacer 120i according to the first modification. Specifically, the spacer 120ii is the base 121 itself, and one or more recesses 121E formed in such a manner that the top surface 121D of the base 121 is recessed in the thickness direction and one or more recesses 121F formed in such a manner that the bottom surface 121B of the base 121 is recessed in the thickness direction are provided from the outer peripheral surface 121A toward the center. As illustrated in FIG. 15, as viewed from the top surface 121D of the base 121, the recesses 121E, 121F extend from the outer peripheral surface 121A to the through-hole 121C of the base 121, unlike the spacer 120i.

As illustrated in FIG. 16, the flowable sealing material 200 charged into the gap having the clearance (t-d) enters the recesses 121E, 121F provided in the top surface 121D and bottom surface 121B of the base 121. In the recess 121E provided in the top surface 121D of the base 121, the flowable sealing material 200 flows to the through-hole 121C along the bottom surface 100A of the package 100. Moreover, in the recess 121F provided in the bottom surface 121B of the base 121, the flowable sealing material 200 flows to the through-hole 121C along the bottom surface 365A of the groove 365. The recesses 121E, 121F are provided in the base 121 so that as in the spacer 120i, the flowable sealing material 200 can be sucked into the extremely-small gaps not only from the outer peripheral surface 121A of the base 121 but also from the recesses due to the capillary action. In addition, in the spacer 120ii, the flowable sealing material 200 having reached the through-hole 121C also easily enters the gaps between the inner peripheral surface of the bolt insertion hole 100C and the outer peripheral surface of the thread portion 110A and between the inner peripheral surface of the internal thread hole 362 and the outer peripheral surface of the thread portion 110A, and almost the entire outer peripheral surface of the thread portion 110A can be sealed with the sealing material 200. Thus, the insulation distance from the back surface 101B of the die pad 101 to the bolt 110 can be further increased, and the insulation performance of the inverter 40 can be improved.

Although the contents of the present invention have been specifically described with reference to the preferred embodiments and the modifications thereof, it is obvious that those skilled in the art can adopt various modifications as follows based on the basic technical idea and teaching of the present invention.

In the above-described embodiment, the recessed part 364 is formed by surrounding the entire circumference of the installation target surface 361 by the partitioning wall 363 standing on the second partition wall 36. Alternatively, the recessed part may be formed in such a manner that the second partition wall 36 is recessed.

The package 100 may be screwed to the installation target surface 361 of the second partition wall 36 without using the spacer 120,120i, 120ii. Even in this case, the flowable sealing material 200 charged into the recessed part 364 can enter the extremely-small gap between the installation target surface 361 of the second partition wall 36 and the bottom surface 100A of the package 100 due to the capillary action.

In the above-described embodiment, the spacer 120,120i, 120ii is disposed in the groove 365 formed in the installation target surface 361 of the second partition wall 36, but the groove 365 may be omitted in a case where the package 100 can be screwed without positioning the spacer 120,120i, 120ii.

The electric motor 20 may be an AC motor or a DC brushed motor other than the permanent magnet synchronous motor, and may be any motor as long as the motor is driven by a drive circuit having one or more power semiconductor elements. Thus, the drive circuit that drives the electric motor 20 is not limited to the inverter 40.

In the package 100 described above, the back surface 101B of the die pad 101 for supporting and fixing the switching element 41 is flush with the bottom surface 100A of the package 100 and is exposed to the outside. However, the present invention is not limited thereto, and a heat dissipating metal plate may be bonded to the back surface 101B of the die pad 101, and the surface of the metal plate opposite to the bonding surface may be flush with the bottom surface 100A of the package 100 and be exposed to the outside.

The package 100 enclosing the switching element 41 is installed on the installation target surface 361 of the second partition wall 36. However, the present invention is not limited thereto, and the installation target surface 361 may be formed in the outer peripheral surface of the peripheral wall of the front housing 33 and the package 100 may be installed on such an installation target surface 361. In this case, the circuit board 50 is screwed to a boss portion standing on the outer peripheral surfaces of the front housing 33 to the center housing 32, and the third space H3 is formed by the outer peripheral surfaces of the front housing 33 to the center housing 32. The package 100 enclosing the switching element 41 may be installed on a base plate separated from the front housing 33 instead of the second partition wall 36. If the back surface of the base plate opposite to the installation target surface 361 for the package 100 is flat, such a back surface is preferably joined to the front housing 33 from the viewpoint of heat dissipation of the switching element 41.

In the base 121 of the spacer 120i according to the first modification, the peripheral wall 121G is not necessarily provided. With this configuration, the flowable sealing material 200 introduced into the recesses also enters the through-hole 121C so that the outer peripheral surface of the thread portion 110A of the bolt 110 can be covered.

The technical ideas described in the above-described embodiments and modifications and the modifications based thereon can be appropriately used in combination as long as there is no inconsistency. For example, even in a case where the package 100 is screwed using the spacer 120i, 120ii according to the first and second modifications, the flowable sealing material 200 may be charged until the surface height of the sealing material 200 reaches the location higher than the head portion 110B of the bolt 110.

### LIST OF REFERENCE SIGNS

3 Electric Compressor
10 Compression Mechanism
20 Electric Motor
30 Housing
33 Front Housing
36 Second Partition Wall (Partition Wall)
40 Inverter (Drive Circuit)
41 Switching Element
50 Circuit Board
100 Package
100A Bottom Surface
100C Bolt Insertion Hole
100D Cutout
101 Die Pad
101A One Surface
102 Lead
110 Bolt
110A Thread Portion
120 Spacer
121 Base
121A Outer Peripheral Surface
121B Bottom Surface
121C Through-Hole
121D Top Surface
121E, 121F Recess
122 Cylindrical Body
200 Sealing Material
361 Installation Target Surface
362 Internal Thread Hole
364 Recessed part
H2 Second Space (Refrigerant Introduction Space)
H3 Third Space (Circuit Housing Space)

1. An electric compressor configured such that a drive circuit that drives an electric motor which is a power source for a compression mechanism is installed integrally with a housing that houses the compression mechanism and the electric motor,
an installation target surface of the housing for a package enclosing a switching element of the drive circuit being provided as a bottom surface of a recessed part formed in the housing,
the package being fixed in such a manner that a thread portion of a bolt inserted into a bolt insertion hole of the package is screwed into a screw hole formed in the installation target surface, and
the recessed part being filled with a sealing material.

2. The electric compressor according to claim 1, wherein
an insulating spacer having a through-hole into which the thread portion of the bolt is to be inserted is interposed between a bottom surface of the package facing the installation target surface and the installation target surface, and
the sealing material is charged between the bottom surface of the package and the installation target surface.

3. The electric compressor according to claim 2, wherein
the spacer further includes a cylindrical body extending from the spacer into the bolt insertion hole along the thread portion of the bolt.

4. The electric compressor according to claim 2, wherein
a recess extending from an outer peripheral surface of the spacer to the through-hole is formed in a top surface of the spacer facing the bottom surface of the package and a bottom surface of the spacer facing the installation target surface.

5. The electric compressor according to claim 1, wherein
the package has a die pad that supports and fixes the switching element and a lead that connects the switching element and a circuit board outside the package, and
the recessed part is filled with the sealing material up to a location higher than a location from which the lead protrudes to the outside of the package and a location at which the die pad is exposed to the outside of the package through a cutout of the package with reference to the installation target surface.

6. The electric compressor according to claim 1, wherein
the drive circuit is housed in a drive circuit housing space adjacent to a refrigerant introduction space into which refrigerant is introduced in the housing, and
the installation target surface is formed on a partition wall that separates the refrigerant introduction space and the drive circuit housing space from each other.
